(19) United States
(12) Patent Application Publication
(10) Pub. No.: US 2017/0155872 A1
(43) Pub. Date: Jun. 1, 2017

(54) METHOD AND DEVICE FOR AUDIO/VIDEO SHARING

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventors: Guannan Yan, Beijing (CN); Zhongbin Tong, Beijing (CN)

(21) Appl. No.: 15/245,052

(22) Filed: Aug. 23, 2016

Related U.S. Application Data
(63) Continuation of application No. PCT/CN2016/087075, filed on Jun. 24, 2016.

(30) Foreign Application Priority Data
Nov. 30, 2015 (CN) 201510857767.0

(51) Int. Cl. H04N 7/16; H04N 21/432; H04N 21/4363; H04N 21/858; H04N 21/4623

(52) U.S. Cl. CPC H04N 7/163; H04N 21/858; H04N 21/4623; H04N 21/4363; H04N 21/4325

(57) ABSTRACT

The embodiment of the present disclosure discloses a method for audio/video sharing and a device for audio/video sharing. The method for audio/video sharing comprises the following steps: generating a two-dimension code according to network information of a wireless local area network where a storage device is located, wherein at least one audio/video is stored in the storage device; transmitting the two-dimension code to a second device so as to play the at least one audio/video in the storage device. According to the embodiment of the present disclosure, as the network information of the wireless local area network where the storage device is located is transmitted to the second device through the generated two-dimension code, the connection establishment process of the second device and the storage device is simplified, and the audio/video can be conveniently shared among a plurality of devices.

### CROSS REFERENCE TO RELATED APPLICATIONS

This application is a continuation of International Application No. PCT/CN2016/087075, filed on Jun. 24, 2016, which claims priority to Chinese Patent Application No. 201510857767.0, filed on Nov. 30, 2015, the entire contents of which are incorporated herein by reference.

### FIELD OF TECHNOLOGY

The present disclosure relates to the technical field of data processing, and in particular to a method and device for audio/video sharing.

### BACKGROUND

At present, a plenty of audio/video play schemes are available, and the most direct one is to acquire a play link of an audio/video in the Internet and input the play link into a browser to play the audio/video. If known audio/videos in the Internet are to be shared with other users to play, the play links of the audio/videos can be shared to other users.

If audio/videos, which are downloaded into a storage device already, are to be shared by other users to play, the audio/videos in the storage device shall be copied to other users to play in a copying mode, however, the storage device can be easily attacked by viruses if the audio/videos are copied among a plurality of users. In addition, the user experience can be degraded since the audio/videos must be copied before being played and the copying speed can be greatly affected by devices.

### SUMMARY

The embodiment of the present disclosure discloses a method and device for audio/video sharing, and aims to solve the problems that a storage device can be easily attacked by viruses when an audio/video is copied and the audio/video must be copied before being played.

The embodiment of the present disclosure provides a method for audio/video sharing, applied to a first device, including: generating a two-dimension code according to network information of a wireless local area network where a storage device is located, wherein at least one audio/video is stored in the storage device; transmitting the two-dimension code to a second device to allow the second device to play at least one audio/video in the storage device.

Correspondingly, the embodiment of the present disclosure further provides a method for audio/video sharing, applied to a second device, including: receiving and analyzing a two-dimension code from a first device, wherein the two-dimension code is generated according to the network information of a wireless local area network where a storage device is located; connecting the storage device according to the analyzed network information; reading audio/video information in the storage device, and playing an audio/video, which is selected and confirmed by a user.

Correspondingly, the embodiment of the present disclosure further provides an electronic device for audio/video sharing, the electronic device including at least one first processor; and a first memory communicably connected with the at least one first processor for storing instructions executable by the at least one first processor, wherein execution of the instructions by the at least one first processor causes the at least one first processor to: generate a two-dimension code according to network information of a wireless local area network where a storage device is located, wherein at least one audio/video is stored in the storage device; transmit the two-dimension code to a second device and play the at least one audio/video in the storage device.

Correspondingly, the embodiment of the present disclosure further provides an electronic device for audio/video sharing, the electronic device including at least one second processor; and a second memory communicably connected with the at least one second processor for storing instructions executable by the at least one second processor, wherein execution of the instructions by the at least one second processor causes the at least one second processor to: receive and analyze a two-dimension code from a first device, wherein the two-dimension code is generated according to network information of a wireless local area network where a storage device is located; connect the storage device according to the analyzed network information; read audio/video information in the storage device; play an audio/video, which is selected and confirmed by a user.

The embodiment of the present disclosure further provides a computing device, including: one or more processors, a memory and one or more modules, wherein the one or more modules are stored in the memory and are configured to be executed by the one or more processors; the one or more modules are configured to execute the method in the embodiment of the present disclosure.

The embodiment of the present disclosure further provides a computer readable storage medium in which a program for executing the method in the embodiment of the present disclosure is recorded.

According to the method and device for audio/video sharing provided by the embodiment of the present disclosure, the two-dimension code is generated according to the network information of the wireless local area network where the storage device in which at least one audio/video is stored is located, and is transmitted to the second device, and then at least one audio/video in the storage device can be played. As the network information of the wireless local area network where the storage device is located is transmitted to the second device through the generated two-dimension code, the connection establishment process of the second device and the storage device is simplified, and the audio/video can be conveniently shared among plurality of devices.

### BRIEF DESCRIPTION OF FIGURES

To clearly describe the technical schemes in the embodiments of the present disclosure, figures needing to be used in the description of the embodiments or the prior art are briefly introduced as follows, obviously, the figures described below are some embodiments of the present disclosure, and for common skilled person in the art, other figures can be also obtained according to the figures under the condition that no creative work is made.

FIG. 1 shows the flow chart of steps of the method for audio/video sharing in one embodiment of the present disclosure.

FIG. 2 shows the flow chart of steps of the method for audio/video sharing in another embodiment of the present disclosure.

FIG. 3 shows the structure schematic diagram of the device for audio/video sharing in one embodiment of the present disclosure.

FIG. 4 shows the structure schematic diagram of the device for audio/video sharing in another embodiment of the present disclosure.

FIG. 5 shows the block diagram of the electronic device for executing the methods of the embodiments of the present disclosure.

FIG. 6 shows the storage unit for maintaining or carrying over program codes for implementing the methods of the embodiments of the present disclosure.

### DESCRIPTION OF THE EMBODIMENTS

To make the purposes, technical schemes and advantages of the embodiments of the present disclosure clearer, the technical schemes in the embodiments of the present disclosure are clearly and completely described with the following figures in the embodiments of the present disclosure, the described embodiments are not all but a part of the embodiments of the present disclosure. Based on the embodiments of the present disclosure, other embodiments obtained by common skilled person in the art under the condition that no creative work is made all belong to the protection scope of the present disclosure.

### Embodiment I

A method for audio/video sharing provided by the embodiment of the present disclosure is specifically described, the method for audio/video sharing is used in a first device, and the first device may be a mobile terminal such as a smart phone and a tablet personal computer.

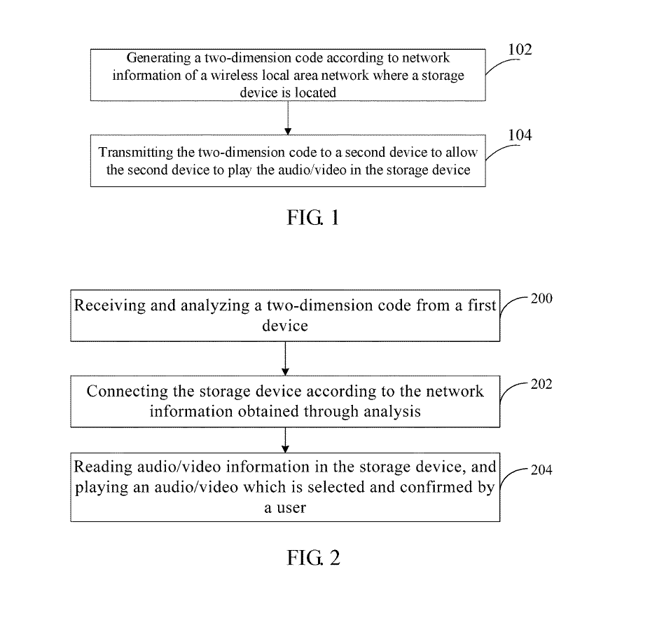

FIG. 1 shows the flow chart of steps of the method for audio/video sharing in the embodiment of the present disclosure.

Step 100, generating a two-dimension code according to network information of a wireless local area network where a storage device is located.

At least one audio/video is stored in the storage device. For example, the storage device may be a net box. The step 100 specifically includes generating the two-dimension code according to the service set identifier and the password of the wireless local area network where the storage device is located, and the IP (Internet Protocol) address of the storage device.

In one optional embodiment of the present disclosure, the step 100 includes: generating a character string according to the network information of the wireless local area network where the storage device is located according to preset rules, and generating the two-dimension code according to the character string, wherein the preset rules include that the network information such as the service set identifier and the password of the wireless local area network and the IP address of the storage device is arranged in a successive sequence. When the character string is generated, a character string of a fixed format is generated according to the network information such as the service set identifier and the password of the wireless local area network and the IP address of the storage device in the successive sequence.

Step 102, transmitting the two-dimension code to a second device to allow the second device to play at least one audio/video in the storage device.

The second device is a mobile terminal such as a smart phone and a tablet personal computer. In one optional embodiment of the present disclosure, the audio/video may be downloaded to a local place in the storage device, so that the download state of the at least one audio/video may be also recorded in the storage device; the download state may include the progress information of the download process and download completion. When the step 102 is carried out, the download state of the audio/video in the storage device may be also acquired, and the download state is transmitted to the second device, so that the download state of the audio/video in the storage device may be shown on the second device, and a user may conveniently select and play the downloaded audio/video.

To sum up, according to the technical scheme of the embodiment of the present disclosure, the two-dimension code is generated according to the network information of the wireless local area network where the storage device in which at least one audio/video is stored is located, and the two-dimension code is transmitted to the second device so as to play the at least one audio/video in the storage device. As the network information of the wireless local area network where the storage device is stored is transmitted to the second device through the generated two-dimension code, the connection establishment process of the second device and the storage device is simplified, and the audio/video may be conveniently shared among a plurality of devices.

### Embodiment II

A method for audio/video sharing provided by the embodiment II of the present disclosure is specifically described, the method for audio/video sharing is used in a second device, and the second device may be a mobile terminal.

FIG. 2 shows the flow chart of steps of the method for audio/video sharing in another embodiment of the present disclosure.

Step 200, receiving and analyzing a two-dimension code from a first device, wherein the two-dimension code is generated from a first device according to network information of a wireless local area network where a storage device is located, and at least one audio/video is stored in the storage device.

The first device and the storage device are kept connected in a wired manner or a wireless manner. In one optional embodiment of the present disclosure, the two-dimension code may be one generated according to a character string, which is generated according to the network information of the wireless local area network where the storage device is located through the first device according to preset rules.

The network information may include a connection account and a password of the network, the IP of the storage device, and the like.

In one optional embodiment of the present disclosure, the two-dimension code may be analyzed by scanning the two-dimension code through a code scanning function. Specifically, the two-dimension code from the first device is scanned through the code scanning function and is analyzed according to preset rules.

The preset rules used when the character string is generated and preset rules used when the two-dimension code is analyzed may be a same set of rules, the preset rules may be defined according to practical situation, and the preset rules are not specifically limited by the embodiments of the present disclosure.

Step 202, connecting the storage device according to the network information obtained through analysis.

After the network is obtained through analysis, the wireless local area network where the storage device is located may be connected according to the network information, and thus connection with the storage device may be further established.

Step 204, reading audio/video information in the storage device, and playing an audio/video, which is selected and confirmed by a user.

In one optional embodiment of the present disclosure, the step of reading the audio/video information in the storage device includes reading the audio/video information in the storage device according to a preset communication protocol, and the audio/video information may include an audio/video list, an audio/video which is downloaded at the moment, the progress of the audio/video which is downloaded at the moment, the linking state of the audio/video, and the like.

The preset communication protocol may be defined according to practical situation, and the preset communication protocol is not specifically limited in the embodiment of the present disclosure.

In one optional embodiment of the present disclosure, the step of playing the audio/video, which is selected and confirmed by the user, includes the following two steps:

step 1, transmitting an instruction of playing the audio/video, which is selected and confirmed by the user to the storage device through a play interface preset in the storage device;

the audio/video which is selected and confirmed by the user may be one selected and confirmed by the user in the audio/video list; when the user selects and confirms the audio/video, transmission of the play instruction may be triggered through operation such as clicking;

step 2, receiving a play link, which is fed back from the storage device, of the audio/video which is selected and confirmed by the user, and playing the audio/video through the play link.

After the storage device receives the play instruction of the audio/video, which is selected and confirmed by the user, the storage device feeds back the play link of the audio/video, which is selected and confirmed by the user in the wireless local area network to the second device.

To sum up, according to the technical scheme of the embodiment of the present disclosure, the first device generates the two-dimension code according to the network information of the wireless local area network where the storage device in which at least one audio/video is stored is located. The second device receives and analyzes the two-dimension code from the first device so as to obtain the network information of the wireless local area network where the storage device is located, establishes connection with the storage device according to the network information, and at the same time acquires the audio/video information in the storage device so as to play the audio/video in the storage device directly. As the network information of the wireless local area network where the storage device is stored is shared through the generated two-dimension code, steps of establishing connection with the storage device and playing the audio/video are simplified, and the audio/video may be conveniently shared among a plurality of devices.

### Embodiment III

An device for audio/video sharing provided by the embodiment III of the present disclosure is specifically described, used in a first device.

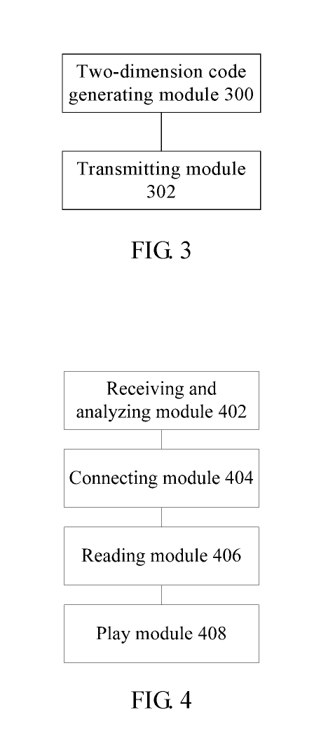

FIG. 3 shows the structure schematic diagram of the device for audio/video sharing in one embodiment of the present disclosure.

The device may include a two-dimension code generating module 300 and a transmitting module 302.

Functions of the modules and the relationship of the modules are specifically described as follows respectively.

The two-dimension code generating module 300 is used for generating a two-dimension code according to network information of a wireless local area network where a storage device is located, wherein at least one audio/video is stored in the storage device.

Optionally, the two-dimension code generating module 300 is used for generating the two-dimension code according to the service set identifier and the password of the wireless local area network where the storage device is located, and the IP of the storage device.

Optionally, the two-dimension code generating module 300 is used for generating a character string according to the network information of the wireless local area network where the storage device is located according to preset rules, and used for generating the two-dimension code according to the character string.

The transmitting module 302 is used for transmitting the two-dimension code to a second device to allow the second device to at least one audio/video in the storage device.

In one optional embodiment of the present disclosure, the download state of the at least one audio/video is also recorded in the storage device; the download state includes the progress information of the download process, and download completion.

The device for audio/video sharing and the storage device in the embodiment of the present disclosure may be located in one same wireless local area network.

To sum up, according to the technical scheme of the embodiment of the present disclosure, the two-dimension code is generated according to the network information of the wireless local area network where the storage device in which at least one audio/video is stored is located, and the two-dimension code is transmitted to the second device so as to play the at least one audio/video in the storage device. As the network information of the wireless local area network where the storage device is located is transmitted to the second device through the generated two-dimension code, the connection establishment process of the second device and the storage device is simplified, and the audio/video may be conveniently shared among a plurality of devices.

### Embodiment IV

A device for audio/video sharing provided by the embodiment IV of the present disclosure is specifically described, and the device for audio/video sharing includes a second device.

FIG. 4 shows the structure schematic diagram of the device for audio/video sharing in another embodiment of the present disclosure.

The device may include a receiving and analyzing module 402, a connecting module 404, a reading module 406 and a play module 408.

Functions of the modules and the relationship of the modules are specifically described as follows respectively.

The receiving and analyzing module 402 is used for receiving and analyzing a two-dimension code from a first device, wherein the two-dimension code is generated according to network information of a wireless local area network where a storage device is located.

The connecting module 404 is used for connecting the storage device according to the network information obtained through analysis.

The reading module 406 is used for reading audio/video information in the storage device.

The play module 408 is used for playing an audio/video, which is selected and confirmed by a user.

Optionally, the receiving and analyzing module 402 is used for scanning the two-dimension code through a code scanning function and used for analyzing the two-dimension code from the first device according to preset rules.

Optionally, the reading module 406 is used for reading the audio/video information in the storage device according to a preset communication protocol, and the audio/video information includes an audio/video list, an audio/video which is downloaded at the moment, the progress of the audio/video which is downloaded at the moment, and the linking state of the audio/video.

Optionally, the play module 408 is used for transmitting an instruction of playing the audio/video which is selected and confirmed by the user to the storage device through a play interface preset in the storage device, used for receiving a play link which is fed back from the storage device, of the audio/video which is selected and confirmed by the user, and used for playing the audio/video through the play link.

To sum up, according to the technical scheme of the embodiment of the present disclosure, the two-dimension code is generated according to the network information of the wireless local area network where the storage device in which at least one audio/video is stored is located. The second device receives and analyzes the two-dimension code from the first device so as to obtain the network information of the wireless local area network where the storage device is located, establishes connection with the storage device according to the network information, and at the same time acquires the audio/video information in the storage device so as to play the audio/video in the storage device directly. As the network information of the wireless local area network where the storage device is located is shared through the generated two-dimension code, steps of establishing connection with the storage device and playing the audio/video are simplified, and the audio/video may be conveniently shared among a plurality of devices.

The embodiments of the device described above are only schematic, a unit, which may be described as a separated part may be or not physically separated, a member for unit display may be or not a physical unit, that is, the member may be located at one place or distributed to multiple network units. A part of or all modules may be selected to achieve the purposes of the schemes of the embodiments according to practical demands. The present disclosure may be understood and implemented by common skilled person in the art without creative work.

The embodiments of the devices of the present disclosure may be achieved through hardware, or a software module operated in one or more processors, or the combination of the hardware and the software module. Technicians of the field shall understand that some or total functions of some or total parts in communication processing equipment in the embodiments of the present disclosure may be achieved in practice by using a microprocessor or a digital signal processor (DSP). The present disclosure also may achieve equipment or device programs (such as computer programs and computer program products) for executing one part or total of the described methods. The program for achieving the present disclosure may be stored on a computer readable medium or may include one or multiple signal forms. The signals may be downloaded from an internet website or provided on a carrier signal or in any other form.

The skilled person in the art may understand that total or partial steps for achieving the embodiments of the methods above may be achieved by hardware related to program instructions, the programs may be stored in a computer readable storage medium, when the programs are executed, the steps including the methods of the embodiments are executed, and while the storage medium includes: ROM, RAM, disks or compact discs and other mediums in which program codes may be stored.

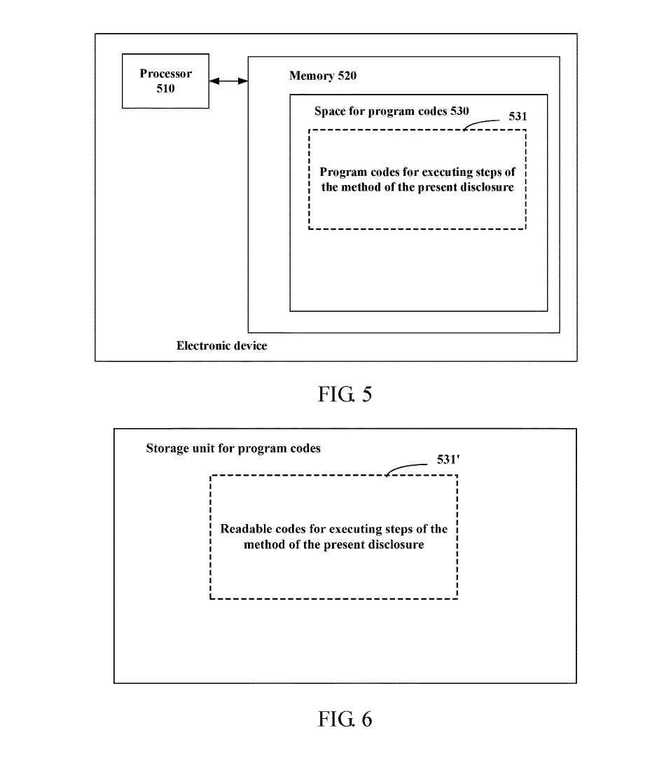

FIG. 5 shows electronic device for realizing the method for audio/video sharing of the present disclosure. The electronic device (such as the storage device and the mobile terminal) traditionally includes a processor 510 and a module (program) product or a readable medium in the mode of a memory 520. The memory 520 may be an electronic memory such as a flash memory, an EEPROM (electronic erasable programmable read-only memory), an EPROM or an ROM. The memory 520 includes a storage space 530 for program codes 531 for executing steps of any one of the methods described above. For example, the storage space 530 for the program codes may include various program codes 531 for realizing different steps of the methods described above respectively. The program codes may be read from one or more program products or written into one or more program products. The program product includes a program code carrier such as a storage card. Such program product is generally a portable or fixed storage unit as shown in FIG. 6. The storage unit may include a storage section, a storage space and the like which are arranged like the memory 520 in the electronic device as shown in FIG. 5. The program codes may be compressed in an appropriate mode. Generally, the storage unit includes readable codes 531′, that is, codes that may be read by a processor such as the processor 510, and when being operated by the processor of the electronic device, the codes may enable the processor of the electronic device to execute different steps of the methods described above.

In addition, typically, the electronic device of the present disclosure may be various handheld terminals such as a mobile phone and a personal digital assistant (PDA), so that the protection scope of the present disclosure does not limit the electronic device as one specific type.

In addition, the method of the present disclosure may also be achieved as a computer program executed by a CPU, and the computer program may be stored in a computer readable storage medium. When the CPU executes the computer program, the functions defined in the methods of the present disclosure may be implemented.

In addition, the steps of the methods and system units may also be achieved by using a controller and the computer readable storage medium in which computer programs for enabling the controller to achieve the steps or unit functions are stored.

In addition, the device of the present disclosure may be used in the electronic device, and the electronic device traditionally includes a processor and a computer program product or a computer readable medium in the mode of a memory. What needs to be understood is that the computer readable storage medium (e.g. memory) in the present disclosure may be a volatile memory or a nonvolatile memory, or may include both the volatile memory and the nonvolatile memory. As an example but nonrestrictive, the nonvolatile memory may also only include a read-only memory (ROM), a programmable ROM (PROM), an electronic programmable ROM (EPROM), an electronic erasable programmable ROM (EEPROM) or a flash memory. The volatile memory may include a random access memory (RAM), and the RAM may be used as an external cache memory. As an example but nonrestrictive, the RAM may be acquired in multiple modes, such as a synchronization RAM (DRAM), a dynamic RAM (DRAM), a synchronization dynamic DRAM (SDRAM), a double data rate SDRAM (DDR SDRAM), an enhanced SDRAM (ESDRAM), a synchronization link DRAM (SLDRAM) and a direct Rambus RAM (DRRAM). The storage device of the present disclosure intends to include but not limited to other suitable types of memories. The memory has a storage space for program codes for executing steps of any one of the methods described above. For example, the storage space for the program codes may include different program codes for achieving the steps of the methods above. The program codes may be read from one or more program products or written into one or more program products. The program product includes a program code carrier such as a disc, a compact disc (CD), a storage card or a floppy disc. Such program product is generally a portable or fixed storage unit. The storage unit may include a storage section, a storage space and the like which are arranged like the memory in the electronic device above. The program codes may be compressed in an appropriate mode. Generally, the storage unit includes readable codes, that is, codes that may be read by the processor above, and when being operated by the electronic device, the codes may enable the electronic device to execute different steps of the methods described above.

The skilled person in the art may also understand that various exemplary logic blocks, modules, circuits and algorithm steps described in the present disclosure may be achieved as electronic hardware, computer software or a combination of the hardware and the computer software. To clearly explain the interchangeability of the hardware and the software, functions of various schematic components, blocks, modules, circuits and steps are generally described. Whether the functions are achieved as software or hardware depends on specific application and design constraint to a whole system. The skilled person in the art may achieve the functions for specific application and various modes, but the achievement decision shall not be interpreted beyond the scope of the present disclosure.

Various exemplary logic blocks, modules and circuits described in the present disclosure may be achieved by the following members for executing the functions: a universal processor, a digital signal processor (DSP), an application-specific integrated circuit (ASIC), a field-programmable gate array (FPGA), other programmable logic devices, splitting gates, transistor logics, split hardware components or any combination of the members. The universal processor may be a microprocessor, but alternatively, the processor may be any conventional processor, controller, microcontroller or state machine. The processor may be also achieved as a combination of electronic device, for example, the combination of DSP and the microprocessor, a plurality of microprocessors, one or more microprocessors with a DSP kernel, or any other similar configuration.

Steps of the methods or algorithms described in the present disclosure may be directly included in hardware, software modules executed by the processor, or a combination of the hardware and the software modules. The software modules may be retained in the RAM, the flash memory, the ROM, the EPROM, the EEPROM, a register, a hard disc, a mobile disc, a CD-ROM or any known storage medium in any other mode in the field. The exemplary storage medium is coupled to the processor, so that the processor may read information from the storage medium or write information into the storage medium. In one alternative scheme, the storage medium may be integrated with the processor. The processor and the storage medium may be retained in an ASIC. The ASIC may be retained in a user terminal. In one alternative scheme, the processor and the storage medium may be used as split components retained in the user terminal.

In one or more exemplary designs, the functions may be achieved in hardware, software, firmware or any combination. When being achieved in software, the functions may be used as one or more instructions or codes stored in the computer readable medium or transmitted through the computer readable medium. The computer readable medium includes a computer storage medium and a communication medium, and the communication medium includes any medium, which is helpful in transmitting computer programs to another position from one position. The storage medium may be any usable medium, which may be accessed by universal or special computers. As an example but nonrestrictive, the computer readable medium may include RAM, ROM, EEPROM, CD-ROM, other disc storage equipment, disc storage equipment, other magnetic storage equipment, or any other medium which may carry over or store expected program codes in a storage mode of instructions or data structures and may be accessed by universal or special computers or universal or special processors. In addition, any connection may be appropriately called as the computer readable medium. For example, if software is transmitted from a website, a server or other remote sources by using a coaxial cable, an optical fiber cable, a twisted-pair, a digital subscriber line (DSL) or a wireless technology such as infrared rays, radio and microwaves, the coaxial cable, the optical fiber cable, the twisted-pair, the DSL or the wireless technology such as infrared rays, radio and microwaves are all included in the definition of the medium. For example, a magnetic disc and an optical disc used in the present disclosure include a compact disc (CD), a laser disc, an optical disc, a digital versatile disc (DVD), a floppy disc and a blue-ray disc, the magnetic disc is generally used for magnetically reproducing data, and the optical disc is used for optically reproducing data through laser. The combination of the contents above shall also be included in the scope of the computer readable medium.

Note that the disclosed exemplary embodiments may be variously changed and modified within the scope defined by the claims of the present disclosure. The functions, steps and/or operation described in the claims of the method in the embodiments of the present disclosure do not need to be executed in any specific sequence. In addition, although elements of the present disclosure may be described or required as single ones, a plurality of the elements may be imagined, unless the elements are clearly limited as singular.

What needs to be understood is that the singular “one” (“a”, “an”, “the”) used in the present disclosure also includes plural unless exceptional cases are clearly supported in the context. What also needs to be understood is that “and/or” used in the present disclosure refers to any and all possible combinations of one or more than one item listed connectedly.

The sequence numbers of the embodiments of the present disclosure are only for description but not represent good and bad of the embodiments.

The common skilled person in the art may understand that total or partial steps of the embodiments above may be achieved through hardware and programs commanding related hardware as well, the programs may be stored in one computer readable storage medium, and the storage medium mentioned above may be a read-only memory, a magnetic disc, an optical disc, etc.

The description above is only relatively optimal embodiments of the present disclosure and is not for limiting the present disclosure, and any modification, equivalent alternation, improvement and the like within the spirit and the principle of the present disclosure shall all belong to the protection scope of the present disclosure.

What is claimed is:

1. A method for audio/video sharing, applied to a first device, comprising:
generating a two-dimension code according to network information of a wireless local area network where a storage device is located, wherein at least one audio/video is stored in the storage device;
transmitting the two-dimension code to a second device to allow the second device to play the at least one audio/video in the storage device.

2. The method according to the claim 1, wherein generating the two-dimension code according to the network information of the wireless local area network where the storage device is located comprises:
generating the two-dimension code according to a service set identifier and a password of the wireless local area network where the storage device is located, and an IP of the storage device.

3. The method according to the claim 1, wherein generating the two-dimension code according to the network information of the wireless local area network where the storage device is located comprises:
generating a character string from the network information of the wireless local area network where the storage device is located according to preset rules, and generating the two-dimension code according to the character string.

4. The method according to the claim 1, wherein a download state of the at least one audio/video is also recorded in the storage device;
the download state comprises progress information of download process and download completion.

5. A method for audio/video sharing, applied to a second device, comprising:
receiving and analyzing a two-dimension code from a first device, wherein the two-dimension code is generated according to network information of a wireless local area network where a storage device is located;
connecting the storage device according to the network information obtained through analysis;
reading audio/video information in the storage device, and playing an audio/video which is selected and confirmed by a user.

6. The method according to the claim 5, wherein analyzing the two-dimension code from the first device comprises:
scanning the two-dimension code through a code scanning function, and analyzing the two-dimension code from the first device according to preset rules.

7. The method according to the claim 5, wherein reading the audio/video information in the storage device comprises:
reading the audio/video information in the storage device according to a preset communication protocol, wherein the audio/video information comprises an audio/video list, an audio/video, which is downloaded at the moment, a progress of the audio/video, which is downloaded at the moment, and a linking state of the audio/video.

8. The method according to the claim 5, wherein playing the audio/video, which is selected and confirmed by the user, comprises:
transmitting an instruction of playing the audio/video, which is selected and confirmed by the user to the storage device through a play interface preset in the storage device;
receiving a play link, which is fed back from the storage device, of the audio/video which is selected and confirmed by the user, and playing the audio/video through the play link.

9. An electronic device for audio/video sharing, comprising:
at least one first processor; and
a first memory communicably connected with the at least one first processor for storing instructions executable by the at least one first processor, wherein execution of the instructions by the at least one first processor causes the at least one first processor to:
generate a two-dimension code according to network information of a wireless local area network where a storage device is located, wherein at least one audio/video is stored in the storage device;
transmit the two-dimension code to a second device to allow the second device to play the at least one audio/video in the storage device.

10. The electronic device according to the claim 9, wherein
generate a two-dimension code according to network information of a wireless local area network where a storage device is located comprises: generate the two-dimension code according to a service set identifier and a password of the wireless local area network where the storage device is located, and an IP of the storage device.

11. The electronic device according to the claim 9, wherein
generate a two-dimension code according to network information of a wireless local area network where a storage device is located comprises: generate a character string from the network information of the wireless local area network where the storage device is located according to preset rules, and generate the two-dimension code according to the character string.

12. The electronic device according to the claim 9, wherein a download state of the at least one audio/video is also recorded in the storage device;
the download state comprises the progress information of download process and download completion.

13. The electronic device according to the claim 9, wherein the electronic device and the storage device are located in the wireless local area network.
